(19) United States
(12) Patent Application Publication
(10) Pub. No.: US 2023/0223522 A1
(43) Pub. Date: Jul. 13, 2023

(54) NEGATIVE ELECTRODE ACTIVE MATERIAL FOR SECONDARY BATTERY, NEGATIVE ELECTRODE FOR SECONDARY BATTERY, AND SECONDARY BATTERY

(71) Applicant: MURATA MANUFACTURING CO., LTD., Kyoto (JP)

(72) Inventors: Qin SI, Kyoto (JP); Daisuke ITO, Kyoto (JP); Yasuhiro IKEDA, Kyoto (JP)

(21) Appl. No.: 18/122,211

(22) Filed: Mar. 16, 2023

Related U.S. Application Data
(63) Continuation of application No. PCT/JP2021/027134, filed on Jul. 20, 2021.

(30) Foreign Application Priority Data
Sep. 18, 2020 (JP) 2020-157182

(51) Int. Cl. H01M 4/36; H01M 10/0525; H01M 4/134; H01M 4/58; C01D 15/02

(52) U.S. Cl. CPC H01M 4/366; H01M 10/0525; H01M 4/134; H01M 4/5825; C01D 15/02; H01M 2004/027

(57) ABSTRACT

A secondary battery includes a positive electrode, a negative electrode including a negative electrode active material, and an electrolytic solution. The negative electrode active material includes a lithium-silicon-containing oxide that includes lithium and silicon as constituent elements and includes magnesium present on a surface layer of the lithium-silicon-containing oxide. The lithium-silicon-containing oxide includes a phase including silicon and a phase including at least one kind of lithium silicate represented by Formula (1). A range in which magnesium is present is within a range of greater than or equal to 10 nm and less than or equal to 3000 nm from a surface of the lithium-silicon-containing oxide in a depth direction. Magnesium forms at least one kind of magnesium silicate represented by Formula (2). A ratio of a number of moles of magnesium to a number of moles of lithium is greater than or equal to 0.1 mol % and less than or equal to 20 mol %,

LiₐSi_{b}O_{c} (1)
where a, b, and c satisfy 1≤a≤6, 1≤b≤3, and 1≤c≤7, respectively,

MgₓSi_{y}O_{z} (2)
where x, y, and z satisfy 1≤x≤3, 1≤y≤2, and 1≤z≤4, respectively.

### CROSS REFERENCE TO RELATED APPLICATIONS

The present application is a continuation of PCT patent application no. PCT/JP2021/027134, filed on Jul. 20, 2021, which claims priority to Japanese patent application no. JP2020-157182, filed on Sep. 18, 2020, the entire contents of which are incorporated herein by reference.

### BACKGROUND

The present application relates to a negative electrode active material for a secondary battery, a negative electrode for a secondary battery, and a secondary battery.

Various kinds of electronic equipment, including mobile phones, have been widely used. Accordingly, a secondary battery is under development as a power source which is smaller in size and lighter in weight and allows for a higher energy density. The secondary battery includes a positive electrode, a negative electrode, and an electrolytic solution. The negative electrode includes a negative electrode active material that is to be involved in charging and discharging reactions.

A configuration of the secondary battery has been considered in various ways. Specifically, a silicon oxide composite that includes silicon, a silicon oxide (SiOₓ (0<x<2)), and an oxide including silicon and an element M (the element M is, for example, Mg) is used as a negative electrode active material. In addition, a silicon oxide (SiOₓ (0<x≤2)) in which atoms of metal such as magnesium are uniformly dispersed is used as a negative electrode active material.

### SUMMARY

The present application relates to a negative electrode active material for a secondary battery, a negative electrode for a secondary battery, and a secondary battery.

Although consideration has been given in various ways regarding a battery characteristic of a secondary battery, a cyclability characteristic of the secondary battery is not sufficient yet. Accordingly, there is room for improvement in terms thereof.

It is therefore desirable to provide a negative electrode active material for a secondary battery, a negative electrode for a secondary battery, and a secondary battery each of which makes it possible to achieve a superior cyclability characteristic.

A negative electrode active material for a secondary battery according to an embodiment includes a lithium-silicon-containing oxide that includes lithium and silicon as constituent elements and includes magnesium present on a surface layer of the lithium-silicon-containing oxide. The lithium-silicon-containing oxide includes a phase including silicon and a phase including at least one kind of lithium silicate represented by Formula (1). A range in which magnesium is present is within a range of greater than or equal to 10 nm and less than or equal to 3000 nm from a surface in a depth direction. Magnesium forms at least one kind of magnesium silicate represented by Formula (2). A ratio of a number of moles of magnesium to a number of moles of lithium is greater than or equal to 0.1 mol % and less than or equal to 20 mol %.

LiₐSi_{b}O_{c} (1)

where a, b, and c satisfy 1≤a≤6, 1≤b≤3, and 1≤c≤7, respectively.

MgₓSi_{y}O_{z} (2)

where x, y, and z satisfy 1≤x≤3, 1≤y≤2, and 1≤z≤4, respectively.

A negative electrode for a secondary battery according to an embodiment includes a negative electrode active material, and the negative electrode active material has a configuration similar to the configuration of the negative electrode active material for a secondary battery according to an embodiment described herein.

A secondary battery according to an embodiment includes a positive electrode, a negative electrode, and an electrolytic solution. The negative electrode has a configuration similar to the configuration of the negative electrode for a secondary battery according to an embodiment described herein.

Here, the term “lithium-silicon-containing oxide” refers to an oxide that includes lithium and silicon as constituent elements as described herein and thus has a so-called Li—Si—O bond.

The term “surface layer” on which magnesium is present refers to a surface of the lithium-silicon-containing oxide and a region in the vicinity of the surface, more specifically, a region from the surface of the lithium-silicon-containing oxide to a predetermined depth (of greater than or equal to 10 nm and less than or equal to 3000 nm), as described herein.

The “ratio” related to the number of moles of lithium and the number of moles of magnesium is calculated based on the following calculation expression: ratio (mol %)=(number of moles of magnesium/number of moles of lithium)×100.

According to the negative electrode active material for a secondary battery, the negative electrode for a secondary battery, or the secondary battery of the embodiment of the present technology, the negative electrode active material for a secondary battery includes the lithium-silicon-containing oxide that includes lithium and silicon as constituent elements and includes magnesium present on the surface layer of the lithium-silicon-containing oxide. The phase configuration of the lithium-silicon-containing oxide, the presence range of magnesium, the bonding state of magnesium, and the content of magnesium satisfy the respective conditions described above. Accordingly, it is possible to achieve a superior cyclability characteristic.

Note that effects of the present technology are not necessarily limited to those described above and may include any of a series of suitable effects described herein in relation to the present technology.

### BRIEF DESCRIPTION OF THE FIGURES

FIG. 1 is a diagram schematically illustrating a configuration of a negative electrode active material for a secondary battery according to an embodiment of the present technology.

FIG. 2 is a perspective view of a configuration of a secondary battery (including a negative electrode for a secondary battery) according to an embodiment of the present technology.

FIG. 3 is a sectional view of a configuration of a battery device illustrated in FIG. 2.

FIG. 4 is a block diagram illustrating a configuration of an application example of the secondary battery.

FIG. 5 is a sectional view of a configuration of a secondary battery for test use.

### DETAILED DESCRIPTION

One or more embodiments of the present technology are described below in further detail including with reference to the drawings. Note that the description is given in the following order.

A description is given of a negative electrode active material for a secondary battery according to an embodiment of the present technology.

The negative electrode active material for a secondary battery (hereinafter simply referred to as a “negative electrode active material”) described herein is a material into which an electrode reactant is insertable and from which the electrode reactant is extractable. The negative electrode active material is used for a negative electrode, of a secondary battery, which causes an electrode reaction to proceed.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. That is, the negative electrode active material is a material into which lithium is insertable as the electrode reactant and from which lithium is extractable as the electrode reactant, and lithium is in an ionic state when being inserted into or extracted from the negative electrode active material.

The negative electrode active material includes a lithium-silicon-containing oxide that includes lithium and silicon as constituent elements and includes magnesium present on a surface layer of the lithium-silicon-containing oxide. That is, the negative electrode active material is a so-called lithium silicic acid-containing oxide a surface of which is doped with magnesium. Thus, magnesium is dispersed in a part (the surface layer) of the lithium-silicon-containing oxide in the negative electrode active material.

The term “lithium-silicon-containing oxide” described above refers to an oxide that includes lithium and silicon as constituent elements and thus has a so-called Li—Si—O bond, as described herein. The lithium-silicon-containing oxide is not particularly limited in composition as long as the lithium-silicon-containing oxide includes one or more of oxides including lithium and silicon as constituent elements.

Accordingly, the negative electrode active material is an oxide that includes lithium and silicon as constituent elements in the entire thereof and further includes magnesium as a constituent element in a part (the surface layer) thereof.

The “surface layer” on which magnesium is present is a surface of the lithium-silicon-containing oxide and a region in the vicinity of the surface, as described herein. More specifically, the surface layer is a region from the surface of the lithium-silicon-containing oxide to a predetermined depth (of greater than or equal to 10 nm and less than or equal to 3000 nm).

That is, magnesium is not present at a center of the lithium-silicon-containing oxide but is present only on the surface layer. More specifically, magnesium is locally present only on the surface of the lithium-silicon-containing oxide and the region in the vicinity of the surface. That is, in a case where the lithium-silicon-containing oxide is in the form of a particle, magnesium is present only within the range from the surface to the predetermined depth of the lithium-silicon-containing oxide in the form of a particle.

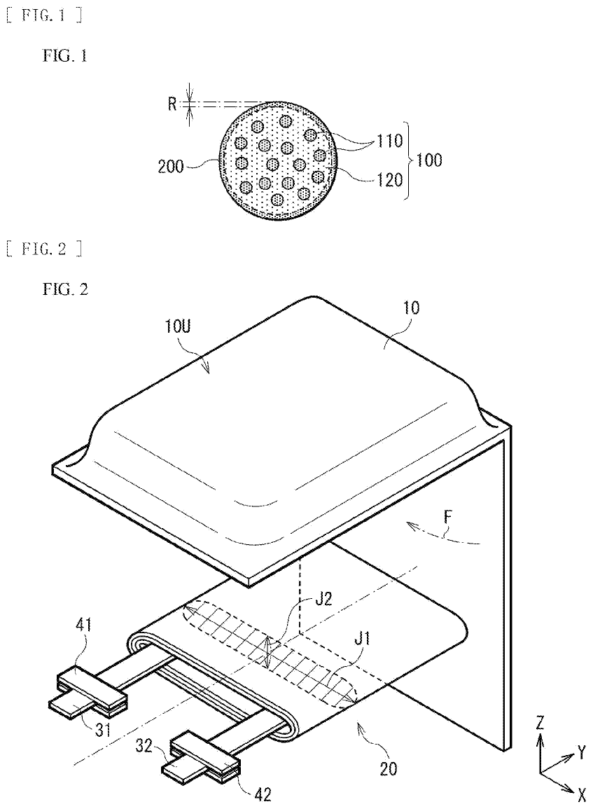

Here, a description is given of a specific configuration of the negative electrode active material. FIG. 1 schematically illustrates a configuration of the negative electrode active material. In FIG. 1, an internal structure of the negative electrode active material is schematically illustrated to facilitate understanding of the configuration of the negative electrode active material.

As illustrated in FIG. 1, the negative electrode active material is a material in the form of a particle including a center part 100 and a surface layer part 200. Note that the negative electrode active material is not particularly limited in shape as long as having a so-called particulate shape. In FIG. 1, a case of the negative electrode active material having a spherical shape is illustrated.

The center part 100 includes the lithium-silicon-containing oxide that includes a silicon phase 110 and a lithium silicate phase 120. The silicon phase 110 is a phase that includes silicon, and the lithium silicate phase 120 is a phase that includes one or more kinds of lithium silicate represented by Formula (1). In FIG. 1, the silicon phase 110 is densely shaded, while the lithium silicate phase 120 is slightly shaded.

LiₐSi_{b}O_{c} (1)

where a, b, and c satisfy 1≤a≤6, 1≤b≤3, and 1≤c≤7, respectively.

Lithium silicate is a so-called lithium-doped silicon oxide, and serves as a solid electrolyte in the negative electrode active material. Lithium silicate is not particularly limited in composition, and specific examples thereof include Li₂SiO₃, Li₂Si₂O₅, Li₄SiO₄, and Li₆Si₂O₇. A reason for this is that lithium silicate sufficiently serves as a solid electrolyte. Lithium silicate may include only one kind of lithium silicate including, without limitation, Li₂SiO₃, or two or more kinds of lithium silicate including, without limitation, Li₂SiO₃, as described above.

A dispersion state of lithium silicate in the lithium silicate phase 120 is not particularly limited. Specifically, one or more of, for example, Li₂SiO₃, Li₂Si₂O₅, and Li₆Si₂O₇ may be dispersed in Li₄SiO₄.

A reason why the center part 100 includes the silicon phase 110 is that lithium is stably inserted into the silicon phase 110 and stably extracted from the silicon phase 110. Further, a reason why the center part 100 includes the lithium silicate phase 120 is that lithium silicate serves as a solid electrolyte to thereby further facilitate insertion of lithium in the center part 100 and extraction of lithium from the center part 100.

In particular, it is preferable that the center part 100 include a plurality of silicon phases 110 and that the plurality of silicon phases 110 be dispersed in the lithium silicate phase 120. A reason for this is that lithium is sufficiently inserted into the center part 100 and sufficiently extracted from the center part 100. In a case of examining the presence of each of the silicon phase 110 and the lithium silicate phase 120, the dispersion state of each of the silicon phase 110 and the lithium silicate phase 120, and the composition of the lithium silicate phase 120 (lithium silicate), the center part 100 may be analyzed by an analytic method such as an X-ray diffraction (XRD) method.

The surface layer part 200 may include magnesium together with the lithium-silicon-containing oxide described above. A reason why the surface layer part 200 includes magnesium is that lithium in the negative electrode active material is prevented from being easily eluted into an aqueous solvent when the negative electrode active material that includes the lithium-silicon-containing oxide is put into the aqueous solvent, as compared with a case where the surface layer part 200 includes no magnesium. This helps to prevent lithium hydroxide (LiOH) from being easily generated in the aqueous solvent, suppressing alkalization of the aqueous solvent. In FIG. 1, the surface layer part 200 is densely shaded.

Here, in FIG. 1, a border line (a broken line) is indicated between the center part 100 and the surface layer part 200 to facilitate understanding of the configuration of the negative electrode active material. However, in the negative electrode active material, magnesium is present only on the surface layer (the surface layer part 200) of the lithium-silicon-containing oxide as described above, and there is no interface between the center part 100 and the surface layer part 200. That is, the center part 100 and the surface layer part 200 are integrated to each other rather than separated from each other. The border line in FIG. 1 is thus indicated by a broken line to indicate that the center part 100 and the surface layer part 200 are continuous with each other and there is no interface between the center part 100 and the surface layer part 200.

The range of the lithium-silicon-containing oxide in which magnesium is present (presence range R) is within the range of greater than or equal to 10 nm and less than or equal to 3000 nm from the surface of the lithium-silicon-containing oxide in the depth direction. A reason for this is that the presence range R is made appropriate, and lithium in the negative electrode active material is thereby sufficiently prevented from being easily eluted in the aqueous solvent. The presence range R is a range extending from the surface of the lithium-silicon-containing oxide in the depth direction, that is, a so-called thickness of the surface layer part 200. In a case of examining the presence range R, the surface layer (the surface layer part 200) of the negative electrode active material may be analyzed by an analytic method such as X-ray photoelectron spectroscopy (XPS).

In particular, it is preferable that the presence range R be within a range of greater than or equal to 50 nm and less than or equal to 3000 nm. A reason for this is that lithium in the negative electrode active material is further prevented from being easily eluted into the aqueous solvent.

In the surface layer part 200, magnesium is bonded to silicon and oxygen in the lithium-silicon-containing oxide, forming a compound having a so-called Mg—Si—O bond. A reason for this is that lithium in the negative electrode active material is prevented from being easily eluted in the aqueous solvent. Specifically, magnesium forms one or more kinds of magnesium silicate represented by Formula (2).

MgₓSi_{y}O_{z} (2)

where x, y, and z satisfy 1≤x≤3, 1≤y≤2, and 1≤z≤4, respectively.

Magnesium silicate is not particularly limited in composition, and specific examples thereof include MgSiO₃ and Mg₂SiO₄. A reason for this is that lithium in the negative electrode active material is sufficiently prevented from being easily eluted in the aqueous solvent. Only one kind of magnesium silicate including, without limitation, MgSiO₃ may be used, or two or more kinds of magnesium silicate including, without limitation, MgSiO₃ may be used, as described above. In a case of examining the presence or composition of magnesium silicate, the surface layer part 200 may be analyzed by an analytic method such as XRD.

A ratio (a molar ratio M) of a number of moles M2 of magnesium to a number of moles M1 of lithium is greater than or equal to 0.1 mol % and less than or equal to 20 mol %. A reason for this is that a relation between the amount of lithium and the amount of magnesium is made appropriate, and lithium in the negative electrode active material is thereby prevented from being easily eluted in the aqueous solvent while the amounts of insertion and extraction of lithium are secured. As described above, the molar ratio M is calculated based on the following calculation expression: molar ratio M (mol %)=(number of moles M2/number of moles M1)×100.

As described below, the negative electrode active material is manufactured by conducting a process of forming a silicon-containing oxide, a process of forming a lithium-silicon-containing oxide (a process of pre-doping the silicon-containing oxide with lithium), and a process of forming the negative electrode active material (a process of doping the surface of the lithium-silicon-containing oxide with magnesium) according to an embodiment.

Silicon (Si) in the form of powder and silicon dioxide (SiO₂) in the form of powder are mixed with each other to thereby obtain a mixture. A mixture ratio (a weight ratio) between silicon and silicon dioxide may be set as desired depending on the composition of the lithium silicate phase 120 (lithium silicate), for example. Thereafter, the mixture is subjected to high-temperature reduction firing to thereby form the silicon-containing oxide (SiOₓ (0<x≤2)) in the form of powder. A firing temperature upon the high-temperature reduction firing is not particularly limited, and is specifically higher than or equal to 1400° C.

First, a lithium metal and an additive are put into a solvent to thereby prepare a lithium-containing solution. The lithium metal is not particularly limited in form (shape), and is specifically a lithium metal piece or a lithium metal foil, for example. The solvent is one or more of organic solvents including, without limitation, ethers. Specific examples of the ethers include N-butyl methyl ether, tetrahydrofuran, dimethyl ether, diethyl ether, dibutyl ether, ethyl vinyl ether, propyl vinyl ether, diphenyl ether, benzyl ether, and benzyl methyl ether. The additive includes one or more compounds including, without limitation, polycyclic aromatic compounds. Specific examples of the polycyclic aromatic compounds include naphthalene and anthracene. Note that the additive may be a compound other than the polycyclic aromatic compounds.

Thereafter, the silicon-containing oxide in the form of powder is put into the lithium-containing solution to thereby cause the silicon-containing oxide to react with lithium in the lithium-containing solution. The silicon-containing oxide is thereby pre-doped with lithium, forming a lithium-doped silicon-containing oxide in the form of powder.

Thereafter, the lithium-doped silicon-containing oxide is collected from the lithium-containing aqueous solution, following which the lithium-doped silicon-containing oxide is dried.

Thereafter, the lithium-doped silicon-containing oxide is fired to thereby form the lithium-silicon-containing oxide in the form of powder including the silicon phase 110 and the lithium silicate phase 120 described above. A firing temperature upon the firing is not particularly limited, and is specifically higher than or equal to 300° C. and lower than or equal to 600° C., preferably higher than or equal to 400° C. and lower than or equal to 600° C. A firing time upon the firing is not particularly limited, and is specifically greater than or equal to 10 minutes and less than or equal to 180 minutes. In this case, a bonding state of lithium in the lithium-silicon-containing oxide is changed by adjusting conditions including, without limitation, the firing temperature and the firing time. The composition of the lithium silicate phase 120 (lithium silicate) is thus controllable.

Lastly, the lithium-silicon-containing oxide is washed with a washing solvent. The washing solvent is not particularly limited in kind, and is one or more of pure water and organic solvents.

The lithium-silicon-containing oxide in the form of powder and magnesium in the form of powder are mixed with each other to thereby obtain a mixture. In this case, a mixture ratio (a weight ratio) is adjusted to cause the molar ratio M to become greater than or equal to 0.1 mol % and less than or equal to 20 mol %.

Thereafter, the mixture is fired. A firing temperature upon the firing is not particularly limited, and is specifically higher than or equal to 300° C. and lower than or equal to 600° C., preferably higher than or equal to 400° C. and lower than or equal to 600° C. A firing time upon the firing is not particularly limited, and is specifically greater than or equal to 10 minutes and less than or equal to 180 minutes. The surface of the lithium-silicon-containing oxide is thereby doped with magnesium, forming magnesium silicate in the lithium-silicon-containing oxide. As a result, the negative electrode active material (the center part 100 and the surface layer part 200) is completed. In this case, a diffusion amount (a surface dope amount) of magnesium in the lithium-silicon-containing oxide is changed by adjusting conditions including, without limitation, the firing temperature and the firing time. The presence range R is thus controllable.

According to the negative electrode active material, the lithium-silicon-containing oxide that includes lithium and silicon as constituent elements and includes magnesium present on the surface layer of the lithium-silicon-containing oxide is included, and the phase configuration of the lithium-silicon-containing oxide, the presence range of magnesium, the bonding state of magnesium, and the content of magnesium satisfy the respective conditions described above.

That is, the lithium-silicon-containing oxide includes the silicon phase 110 and the lithium silicate phase 120. The presence range R is within the range of greater than or equal to 10 nm and less than or equal to 3000 nm. Magnesium forms magnesium silicate. The molar ratio M is greater than or equal to 0.1 mol % and less than or equal to 20 mol %.

In this case, an appropriate range of the surface of the lithium-silicon-containing oxide is doped with magnesium, preventing lithium in the negative electrode active material from being easily eluted in the aqueous solvent when the negative electrode active material is put into the aqueous solvent. This helps to prevent lithium hydroxide from being easily generated in the aqueous solvent, suppressing alkalization of the aqueous solvent.

Further, the lithium-silicon-containing oxide includes the silicon phase 110, facilitating stable insertion of lithium into the silicon phase 110 and stable extraction of lithium from the silicon phase 110. In addition, the lithium-silicon-containing oxide includes the lithium silicate phase 120 serving as a solid electrolyte. The lithium silicate phase 120 is used to further facilitate the insertion and extraction of lithium.

Further, the relation between the amount of lithium and the amount of magnesium is made appropriate. This helps to further prevent lithium in the negative electrode active material from being easily eluted in the aqueous solvent while securing the amounts of insertion and extraction of lithium.

Accordingly, alkalization of the aqueous solvent is suppressed while a stable and smooth insertion-extraction property of lithium is secured. It is therefore possible to achieve a superior cyclability characteristic of the secondary battery including the negative electrode active material.

In particular, lithium silicate may include Li₂SiO₃, for example. In this case, lithium silicate sufficiently serves as a solid electrolyte. It is therefore possible to achieve higher effects.

In addition, magnesium silicate may include MgSiO₃, for example. In this case, lithium in the negative electrode active material is sufficiently prevented from being easily eluted in the aqueous solvent. It is therefore possible to achieve higher effects.

In addition, the presence range R may be within the range of greater than or equal to 50 nm and less than or equal to 3000 nm. In this case, lithium in the negative electrode active material is sufficiently prevented from being easily eluted in the aqueous solvent. It is therefore possible to achieve higher effects.

A description is given next of a secondary battery according to an embodiment of the present technology. A negative electrode for a secondary battery (hereinafter simply referred to as a “negative electrode”) according to an embodiment of the present technology is a portion or a component of the secondary battery, and is thus described together below.

The secondary battery to be described herein is a secondary battery that obtains a battery capacity using insertion and extraction of an electrode reactant, and includes a positive electrode, a negative electrode, and an electrolytic solution. The electrolytic solution is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

In the following, a description is given of an example case where the electrode reactant is lithium as described above. A secondary battery that obtains a battery capacity using insertion and extraction of lithium is a so-called lithium-ion secondary battery.

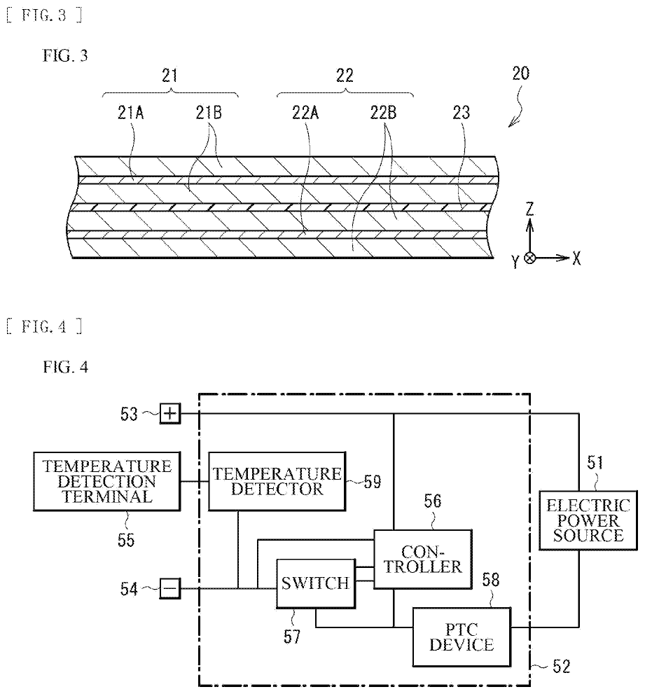

FIG. 2 illustrates a perspective configuration of the secondary battery, and FIG. 3 illustrates a sectional configuration of a battery device 20 illustrated in FIG. 2. Note that FIG. 2 illustrates a state in which an outer package film 10 and the battery device 20 are separated away from each other, and that FIG. 3 illustrates only a portion of the battery device 20.

As illustrated in FIG. 2, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used as an outer package member to contain the battery device 20.

As illustrated in FIG. 1, the outer package film 10 is a flexible outer package member that contains the battery device 20. The outer package film 10 has a pouch-shaped structure in which the battery device 20 is sealed in a state of being contained inside the outer package film 10. The outer package film 10 thus contains a positive electrode 21, a negative electrode 22, and an electrolytic solution that are to be described later.

The outer package film 10 is not particularly limited in a three-dimensional shape. Specifically, the outer package film 10 has a three-dimensional shape conforming to a three-dimensional shape of the battery device 20. Here, the outer package film 10 has an elongated, generally cuboid three-dimensional shape conforming to an elongated three-dimensional shape of the battery device 20 to be described later.

The outer package film 10 is not particularly limited in configuration (e.g., material and number of layers). The outer package film 10 may thus be a single-layered film or a multilayered film. Here, the outer package film 10 is a single film and is foldable in a direction of an arrow F (an alternate long and short dash line). The outer package film 10 has a depression part 10U to place the battery device 20 therein. The depression part 10U is a so-called deep drawn part.

Specifically, the outer package film 10 is a multilayered film (laminated film) including three layers: a fusion-bonding layer, a metal layer, and a surface protective layer that are stacked in this order from an inner side. In a state in which the outer package film 10 is folded, outer edge parts of the fusion-bonding layer opposed to each other are bonded to each other. The fusion-bonding layer includes a polymer compound such as polypropylene. The metal layer includes a metal material such as aluminum. The surface protective layer includes a polymer compound such as nylon.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. The sealing film 41 includes a polymer compound such as a polyolefin that has adherence to the positive electrode lead 31. Specific examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 1 and 2, the battery device 20 is contained inside the outer package film 10, and includes the positive electrode 21, the negative electrode 22, a separator 23, and the electrolytic solution (not illustrated).

The battery device 20 is a so-called wound electrode body. That is, in the battery device 20, the positive electrode 21 and the negative electrode 22 are stacked on each other with the separator 23 interposed therebetween, and the positive electrode 21, the negative electrode 22, and the separator 23 are wound about a winding axis P. The winding axis P is a virtual axis extending in a Y-axis direction. Thus, the positive electrode 21 and the negative electrode 22 are opposed to each other with the separator 23 interposed therebetween, and are wound.

Here, the battery device 20 has an elongated, generally cylindrical three-dimensional shape. Accordingly, a section of the battery device 20 intersecting the winding axis P, that is, a section of the battery device 20 along an XZ plane, has an elongated shape defined by a major axis J1 and a minor axis J2, more specifically, an elongated, generally elliptical shape. The major axis J1 is a virtual axis that extends in an X-axis direction and has a relatively large length. The minor axis J2 is a virtual axis that extends in a Z-axis direction intersecting the X-axis direction and has a relatively small length.

The positive electrode 21 includes, as illustrated in FIG. 3, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Examples of the metal material include aluminum.

Here, the positive electrode active material layer 21B is provided on each of the two opposed surfaces of the positive electrode current collector 21A. The positive electrode active material layer 21B includes one or more of positive electrode active materials into which lithium is insertable and from which lithium is extractable. Note that the positive electrode active material layer 21B may be provided only on one of the two opposed surfaces of the positive electrode current collector 21A on a side where the positive electrode 21 is opposed to the negative electrode 22. In addition, the positive electrode active material layer 21B may further include, for example, a positive electrode binder and a positive electrode conductor. A method of forming the positive electrode active material layer 21B is not particularly limited, and is specifically a coating method, for example.

The positive electrode active material includes a lithium compound. The lithium compound is a compound that includes lithium as a constituent element, more specifically, a compound that includes lithium and one or more transition metal elements as constituent elements, for example. A reason for this is that a high energy density is obtainable. Note that the lithium compound may further include one or more other elements other than lithium and the transition metal elements. The lithium compound is not particularly limited in kind, and is specifically an oxide, a phosphoric acid compound, a silicic acid compound, or a boric acid, for example. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 22 includes, as illustrated in FIG. 3, a negative electrode current collector 22A and a negative electrode active material layer 22B.

The negative electrode current collector 22A has two opposed surfaces on each of which the negative electrode active material layer 22B is to be disposed. The negative electrode current collector 22A includes an electrically conductive material such as a metal material. Examples of the metal material include copper.

Here, the negative electrode active material layer 22B is provided on each of the two opposed surfaces of the negative electrode current collector 22A, and includes the negative electrode active material described above. Note that the negative electrode active material layer 22B may be provided only on one of the two opposed surfaces of the negative electrode current collector 22A on a side where the negative electrode 22 is opposed to the positive electrode 21. In addition, the negative electrode active material layer 22B may further include, for example, a negative electrode binder and a negative electrode conductor. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

Details of the negative electrode binder are similar to those of the positive electrode binder, and details of the negative electrode conductor are similar to those of the positive electrode conductor.

Note that the negative electrode active material layer 22B may further include one or more of other negative electrode active materials into which lithium is insertable and from which lithium is extractable. The other negative electrode active materials are carbon materials, metal-based materials, or both, for example. A reason for this is that a high energy density is obtainable.

Examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. The metal elements and the metalloid elements are silicon, tin, or both. Note that the metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4). Note that the negative electrode active material described above (see FIG. 1) is excluded from the metal-based materials described here.

As illustrated in FIG. 3, the separator 23 is an insulating porous film interposed between the positive electrode 21 and the negative electrode 22, and allows lithium ions to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution. The electrolytic solution includes a solvent and an electrolyte salt.

The solvent includes one or more of non-aqueous solvents (organic solvents) including, without limitation, a carbonic-acid-ester-based compound, a carboxylic-acid-ester-based compound, and a lactone-based compound. The electrolytic solution including the non-aqueous solvent(s) is a so-called non-aqueous electrolytic solution. The electrolyte salt includes one or more of light metal salts including, without limitation, a lithium salt.

As illustrated in FIG. 2, the positive electrode lead 31 is a positive electrode terminal coupled to the battery device 20 (the positive electrode 21). More specifically, the positive electrode lead 31 is coupled to the positive electrode current collector 21A. The positive electrode lead 31 is led to an outside of the outer package film 10. The positive electrode lead 31 includes an electrically conductive material such as aluminum. The positive electrode lead 31 is not particularly limited in shape, and specifically has a shape such as a thin plate shape or a meshed shape.

As illustrated in FIG. 2, the negative electrode lead 32 is a negative electrode terminal coupled to the battery device 20 (the negative electrode 22). More specifically, the negative electrode lead 32 is coupled to the negative electrode current collector 22A. The negative electrode lead 32 is led to the outside of the outer package film 10. The negative electrode lead 32 includes an electrically conductive material such as copper. Here, the negative electrode lead 32 is led toward a direction similar to that in which the positive electrode lead 31 is led out. Note that details of a shape of the negative electrode lead 32 are similar to those of the shape of the positive electrode lead 31.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

The positive electrode 21 and the negative electrode 22 are each fabricated, and the electrolytic solution is prepared, following which the secondary battery is fabricated using the positive electrode 21, the negative electrode 22, and the electrolytic solution, according to a procedure described below.

First, the positive electrode active material, the positive electrode binder, and the positive electrode conductor are mixed with each other to thereby prepare a positive electrode mixture. Thereafter, the positive electrode mixture is put into the solvent to thereby prepare a paste positive electrode mixture slurry. The solvent is not particularly limited in kind, and may be specifically an aqueous solvent or a non-aqueous solvent (an organic solvent). The aqueous solvent is, for example, pure water, and details of the kind of the aqueous solvent described here are similarly applied to the following descriptions. Lastly, the positive electrode mixture slurry is applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, the positive electrode active material layers 21B may be heated, or may be compression-molded multiple times. As a result, the positive electrode 21 is fabricated.

The negative electrode active material layer 22B including the negative electrode active material described above is formed on each of the two opposed surfaces of the negative electrode current collector 22A by a procedure similar to the fabrication procedure of the positive electrode 21. Specifically, the negative electrode active material, the negative electrode binder, and the negative electrode conductor are mixed with each other to prepare a negative electrode mixture. Thereafter, the negative electrode mixture is put into the solvent (the aqueous solvent) to thereby prepare a paste negative electrode mixture slurry. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. As a result, the negative electrode 22 is fabricated.

The electrolyte salt is put into the solvent. The electrolyte salt is thereby dispersed or dissolved in the solvent. As a result, the electrolytic solution is prepared.

First, the positive electrode lead 31 is coupled to the positive electrode 21 (the positive electrode current collector 21A) by a method such as a welding method, and the negative electrode lead 32 is coupled to the negative electrode 22 (the negative electrode current collector 22A) by a method such as welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). The wound body has a configuration similar to that of the battery device 20 except that the positive electrode 21, the negative electrode 22, and the separator 23 are not each impregnated with the electrolytic solution. Thereafter, the wound body is pressed by means of, for example, a pressing machine, to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the outer package film 10 (the fusion-bonding layer) opposed to each other are bonded to each other by a method such as a thermal-fusion-bonding method to thereby place the wound body in the outer package film 10 having the pouch shape.

Lastly, the electrolytic solution is injected into the outer package film 10 having the pouch shape, following which the outer edge parts of the remaining one side of the outer package film 10 (the fusion-bonding layer) are bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32. The wound body is thereby impregnated with the electrolytic solution. Thus, the battery device 20 that is a wound electrode body is fabricated, and the battery device 20 is sealed in the outer package film 10 having the pouch shape. As a result, the secondary battery is assembled.

The assembled secondary battery is charged and discharged. Conditions including, without limitation, an environment temperature, the number of times of charging and discharging (the number of cycles), and charging and discharging conditions may be set as desired. As a result, a film is formed on a surface of the negative electrode 22 and other components, which electrochemically stabilizes a state of the secondary battery. As a result, the secondary battery of the laminated-film type is completed.

According to the secondary battery, the negative electrode 22 includes the negative electrode active material described herein according to an embodiment.

In this case, alkalization of the negative electrode mixture slurry is suppressed upon preparation of the negative electrode mixture slurry using the aqueous solvent as a solvent, suppressing polymerization (agglomeration) of the negative electrode binder in the negative electrode mixture slurry. This facilitates dispersion of the negative electrode binder in the negative electrode mixture slurry, increasing an adhesion strength (peel strength) of the negative electrode active material layer 22B to the negative electrode current collector 22A. Accordingly, the negative electrode active material layer 22B is prevented from easily collapsing and easily falling off from the negative electrode current collector 22A.

Further, insertion of lithium into the negative electrode 22 (the negative electrode active material layer 22B) and extraction of lithium from the negative electrode 22 are facilitated as described above, securing the amounts of insertion and extraction of lithium.

Accordingly, the adhesion state of the negative electrode active material layer 22B to the negative electrode current collector 22A is maintained while the amounts of insertion and extraction of lithium are secured even if charging and discharging is repeated. This helps to prevent a discharging capacity from easily decreasing regardless of repeated charging and discharging. It is therefore possible to achieve a superior cyclability characteristic.

In particular, the secondary battery may include a lithium-ion secondary battery. In this case, a sufficient battery capacity is stably obtainable through the use of insertion and extraction of lithium. It is therefore possible to achieve higher effects.

Further, the negative electrode 22 includes the negative electrode active material described herein according to an embodiment. Accordingly, the adhesion state of the negative electrode active material layer 22B to the negative electrode current collector 22A is maintained while the amounts of insertion and extraction of lithium are secured, as described above. It is therefore possible to achieve a superior cyclability characteristic of the secondary battery including the negative electrode 22.

Note that other action and effects of each of the secondary battery and the negative electrode 22 are similar to those of the negative electrode active material described herein according to an embodiment.

The configuration of the secondary battery is appropriately modifiable including as described below according to an embodiment. Note that any two or more of the following series of modifications may be combined with each other.

The separator 23 which is a porous film is used. However, although not specifically illustrated here, a separator of a stacked type including a polymer compound layer may be used instead of the separator 23 which is the porous film.

Specifically, the separator of the stacked type includes a porous film having two opposed surfaces, and the polymer compound layer disposed on one of or each of the two opposed surfaces of the porous film. A reason for this is that adherence of the separator to each of the positive electrode 21 and the negative electrode 22 improves to suppress the occurrence of misalignment (irregular winding) of the battery device 20. This helps to prevent the secondary battery from easily swelling even if, for example, a decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. Examples of the insulating particles include inorganic particles and resin particles. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and an organic solvent is prepared, following which the precursor solution is applied on one of or each of the two opposed surfaces of the porous film. In this case, insulating particles may be added to the precursor solution on an as-needed basis.

In the case where the separator of the stacked type is used also, lithium ions are movable between the positive electrode 21 and the negative electrode 22, and similar effects are therefore obtainable.

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. A reason for this is that liquid leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and the organic solvent is prepared, following which the precursor solution is applied on one side or both sides of the positive electrode 21 and one side or both sides of the negative electrode 22.

In a case where the electrolyte layer is used also, lithium ions are movable between the positive electrode 21 and the negative electrode 22 via the electrolyte layer, and similar effects are therefore obtainable.

Applications (application examples) of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment including portable electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. These applications may each use one secondary battery, or may each use multiple secondary batteries.

The battery pack may include a single battery, or may include an assembled battery. The electric vehicle is a vehicle that operates (travels) using the secondary battery as a driving power source, and may be a hybrid automobile that is additionally provided with a driving source other than the secondary battery as described above. In the electric power storage system for home use, electric power accumulated in the secondary battery which is an electric power storage source may be utilized for using, for example, home appliances.

Now, a specific description is given of an application example of the secondary battery according to an embodiment. The configuration of the application example described below is merely an example, and is appropriately modifiable.

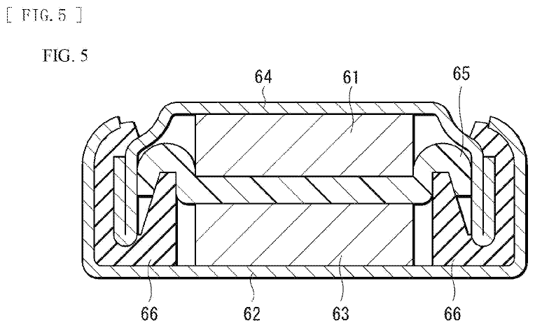

FIG. 4 illustrates a block configuration of a battery pack. The battery pack described here is a battery pack (a so-called soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.2 V±0.05 V. The overdischarge detection voltage is not particularly limited, and is specifically 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge/discharge control upon abnormal heat generation or in a case where the controller 56 performs a correction process upon calculating a remaining capacity.

### EXAMPLES

A description is given of Examples of the present technology according to an embodiment.

### Examples 1 to 14 and Comparative Examples 1 to 5

FIG. 5 illustrates a sectional configuration of a secondary battery of a coin type for test use. As described below, negative electrode active materials were manufactured, and secondary batteries of a coin type were fabricated using the negative electrode active materials, following which the secondary batteries were evaluated for their battery characteristics.

As illustrated in FIG. 5, the secondary battery of the coin type includes a test electrode 61 placed inside an outer package cup 64, and includes a counter electrode 63 placed inside an outer package can 62. The test electrode 61 and the counter electrode 63 are stacked on each other with a separator 65 interposed therebetween, and the outer package can 62 and the outer package cup 64 are crimped to each other by means of a gasket 66. The test electrode 61, the counter electrode 63, and the separator 65 are each impregnated with an electrolytic solution.

### [Manufacture of Negative Electrode Active Material]

In accordance with a procedure described below, the negative electrode active materials were manufactured.

### Manufacture of Negative Electrode Active Materials in Examples 1 to 14 and Comparative Examples 4 and 5

First, silicon powder and silicon dioxide powder were mixed with each other to thereby obtain mixed powder. In this case, a mixture ratio (a weight ratio) between the silicon powder and the silicon dioxide was set to 25:75. Thereafter, the mixture was subjected to high-temperature reduction firing at a firing temperature of 1400° C. to thereby form silicon-containing oxide powder.

Thereafter, a lithium metal piece (0.2 mm in thickness) and an additive (naphthalene) were put into a solvent (N-butyl methyl ether), following which the solvent was stirred to thereby prepare a lithium-containing solution. In this case, a ratio (a weight ratio) between the lithium metal piece and the additive put into the solvent was set to 90:10. Thereafter, the silicon-containing oxide powder was put into the lithium-containing solution, following which the lithium-containing solution was stirred to thereby cause the silicon-containing oxide to react with the lithium-containing solution. The silicon-containing oxide was thereby pre-doped with lithium, forming powder of a lithium-doped silicon-containing oxide. In this case, the amount of the silicon-containing oxide powder put into the lithium-containing solution was 70 wt %. Thereafter, the powder of the lithium-doped silicon-containing oxide was collected from the lithium-containing aqueous solution, following which the powder of the lithium-doped silicon-containing oxide was dried.

Thereafter, the powder of the lithium-doped silicon-containing oxide was fired for a firing time of 60 minutes, to thereby form lithium-silicon-containing oxide powder. In this case, three firing temperatures were set to thereby form three lithium-silicon-containing oxides. Specifically, a firing temperature was set to 580° C. to thereby form a lithium-silicon-containing oxide (LiSiOA). In addition, the firing temperature was set to 500° C. to thereby form a lithium-silicon-containing oxide (LiSiOB). Further, the firing temperature was set to 400° C. to thereby form a lithium-silicon-containing oxide (LiSiOC). Thereafter, the lithium-silicon-containing oxide powder was washed using a washing solvent (dimethyl carbonate), following which the lithium-silicon-containing oxide powder was further washed using another washing solvent (pure water).

The lithium-silicon-containing oxide was analyzed by XRD, and a result of the analysis indicated that the lithium-silicon-containing oxide included the silicon phase 110 and the lithium silicate phase 120. As presented in Tables 1 and 2, the lithium silicate phase 120 included Li₂SiO₃, Li₂Si₂O₅, Li₄SiO₄, and Li₆Si₂O₇.

Thereafter, the lithium-silicon-containing oxide powder and magnesium powder were mixed with each other to thereby obtain mixed powder. In this case, a mixture ratio (a weight ratio) between the lithium-silicon-containing oxide powder and the magnesium powder was changed to thereby adjust the molar ratio M (mol %) as presented in Tables 1 and 2.

Boxes of “Surface dope” in each of Tables 1 and 2 indicate whether the surface of the lithium-silicon-containing oxide was doped with magnesium. The boxes of “Surface dope” of Examples 1 to 14 and Comparative examples 4 and 5 indicate “Mg” because the surface of the lithium-silicon-containing oxide was doped with magnesium.

Lastly, the mixed powder was fired. The surface of the lithium-silicon-containing oxide was thereby doped with magnesium, and as a result, the negative electrode active material in the form of powder having a median diameter D50 of 6.5 μm was completed. In this case, a firing temperature was changed within a range of higher than or equal to 300° C. and lower than or equal to 600° C., and a firing time was changed within a range of greater than or equal to 10 minutes and less than or equal to 180 minutes, to thereby adjust the presence range R (nm) as presented in Tables 1 and 2.

The negative electrode active material was analyzed by XRD, and a result of the analysis indicated that magnesium formed magnesium silicate. The magnesium silicate included MgSiO₃ and Mg₂SiO₄ as presented in Tables 1 and 2.

### Manufacture of Negative Electrode Active Material in Comparative Examples 1 to 3

A similar procedure was conducted except that the surfaces of the lithium-silicon-containing oxides (LiSiOA, LiSiOB, and LiSiOC) were not doped with magnesium, and the lithium-silicon-containing oxides, as they were, were thus used as the negative electrode active materials.

### Fabrication of Secondary Battery in Examples 1 to 14 and Comparative Examples 1 to 5

Lithium-ion secondary batteries of a coin type illustrated in FIG. 5 were fabricated using the series of negative electrode active materials described above according to a procedure described below.

### (Fabrication of Test Electrode)

First, 80 parts by mass of the negative electrode active material, 5 parts by mass of the negative electrode binder (styrene-butadiene-based rubber), 10 parts by mass of the negative electrode conductor (carbon black), and 5 parts by mass of a thickener (carboxymethyl cellulose) were mixed with each other to thereby prepare a negative electrode mixture. Thereafter, the negative electrode mixture was put into a solvent (pure water that is an aqueous solvent), following which the negative electrode mixture was kneaded by means of a rotation and revolution mixer to thereby prepare a paste negative electrode mixture slurry. Thereafter, the negative electrode mixture slurry was applied to one of the two opposed surfaces of the negative electrode current collector (a copper foil having a thickness of 12 μm) by means of a coating apparatus, following which the negative electrode mixture slurry was heated and dried at a heating temperature of 120° C. Thereafter, the negative electrode mixture slurry was subjected to vacuum drying to thereby form the negative electrode active material layer. Lastly, the negative electrode active material layer was compression-molded by means of a roll pressing machine. As a result, the test electrode 61 was fabricated.

### (Preparation of Counter Electrode)

Here, in order to fabricate a secondary battery for test use, a lithium metal plate was used as the counter electrode 63.

### (Preparation of Electrolytic Solution)

An electrolyte salt (lithium hexafluorophosphate) was added to a solvent (ethylene carbonate and ethyl methyl carbonate), following which the solvent was stirred. In this case, a mixture ratio (a mass ratio) between ethylene carbonate and ethyl methyl carbonate in the solvent was 50:50, and a content of the electrolyte salt was 1 mol/l (=1 mol/dm³) with respect to the solvent. As a result, the electrolytic solution was prepared.

### (Assembly of Secondary Battery)

First, the test electrode 61 was placed inside the outer package cup 64, and the counter electrode 63 was placed inside the outer package can 62. Thereafter, the test electrode 61 placed inside the outer package cup 64 and the counter electrode 63 placed inside the outer package can 62 were stacked on each other with the separator 65 (a fine porous polyethylene film having a thickness of 25 μm) impregnated with the electrolytic solution interposed therebetween. In this case, the gasket 66 (a fluororesin film having a thickness of 1.1 mm) was interposed between the outer package cup 64 and the outer package can 62. Lastly, the outer package cup 64 and the outer package can 62 were crimped to each other by means of the gasket 66.

Accordingly, the test electrode 61, the counter electrode 63, and the separator 65 were sealed in the outer package cup 64 and the outer package can 62. As a result, the secondary battery of the coin type was assembled.

### (Stabilization of Secondary Battery)

The secondary battery was charged and discharged for one cycle in an ambient temperature environment (23° C. in temperature). Upon the charging, the secondary battery was charged with a constant current of 0.2 C until a voltage reached 0.05 V, and was thereafter charged with a constant voltage of 0.05 V until a current reached 0.025 C. Upon the discharging, the secondary battery was discharged with a constant current of 0.2 C until the voltage reached 1.5 V. Note that 0.2 C is a value of a current that causes a battery capacity (a theoretical capacity) to be completely discharged in 5 hours, and 0.025 C is a value of a current that causes the battery capacity to be completely discharged in 40 hours.

As a result, the secondary battery of the coin type was completed.

### [Evaluation of Battery Characteristic]

The secondary batteries were evaluated for their cyclability characteristics as battery characteristics. Results obtained by the evaluations are presented in Tables 1 and 2.

In a case of evaluating the cyclability characteristic, first, the secondary battery was charged and discharged in an ambient temperature environment (23° C. in temperature) to thereby measure a discharge capacity (a first-cycle discharge capacity). Thereafter, the secondary battery was repeatedly charged and discharged in the same environment until total number of cycles reached 100 cycles to thereby measure the discharge capacity (a 100th-cycle discharge capacity). Lastly, a capacity retention rate of the secondary battery was calculated based on the following calculation expression: capacity retention rate (%)=(100th-cycle discharge capacity/first-cycle discharge capacity)×100.

Charging and discharging conditions were similar to those for stabilizing the secondary battery described above, except that the current at the time of charging and the current at the time of discharging were each changed to 0.7 C. Note that 0.7 C is a value of a current that causes the battery capacity to be completely discharged in 10/7 hours.

Here, for confirmation, evaluations were conducted on not only the battery characteristic (cyclability characteristic) described above but also manufacturing stability of the secondary battery (stability of the negative electrode mixture slurry) that influences the battery characteristic.

In a case of evaluating the stability of the negative electrode mixture slurry, the negative electrode mixture slurry was prepared by the procedure described above, following which a state of the negative electrode mixture slurry was visually confirmed. It was thereby determined whether the negative electrode mixture slurry had been gelated due to the polymerization (agglomeration) of the negative electrode binder.

In addition, instead of examining a degree of alkalinity (pH) of the negative electrode mixture slurry, an amount of generation (%) of lithium hydroxide that influences a pH of the negative electrode mixture slurry was examined.

Specifically, first, 10 g of the negative electrode active material was weighed, following which the negative electrode active material was put into a sample bottle. Thereafter, 40 ml (=40 cm³) of pure water was put into the sample bottle, following which the content in the sample bottle was stirred for a stirring time of three days to thereby prepare a dispersion solution including the pure water in which the negative electrode active material was dispersed. Thereafter, the dispersion solution was subjected to centrifugal separation by means of a centrifugal separator, following which the dispersion solution was filtered to thereby collect a supernatant liquid. Thereafter, the supernatant liquid was dried at a drying temperature of 105° C. to thereby collect lithium hydroxide which was a precipitate. Lastly, an elution amount of the precipitate was calculated based on a weight of the dispersion solution and a weight of the precipitate. The elution amount was calculated based on the following calculation expression: elution amount (%)=(weight of precipitate/weight of dispersion solution)×100.

TABLE 1

| | Lithium- | | | | | | | | Capacity |
|---|---|---|---|---|---|---|---|---|---|
| | silicon- | | | | Presence | Molar | | Elution | retention |
| | containing | Surface | Lithium | Magnesium | range | ratio | | amount | rate |
| | oxide | dope | silicate | silicate | R (nm) | M (mol %) | Gelation | (%) | (%) |
| Example 1 | LiSiOA | Mg | Li₂SiO₃ | MgSiO₃ | 10 | 0.1 | Not occurred | 2.50 | 75.6 |
| Example 2 | | | Li₂Si₂O₅ | Mg₂SiO₄ | 50 | 0.5 | Not occurred | 1.30 | 83.3 |
| Example 3 | | | Li₄SiO₄ | | 255 | 2 | Not occurred | 0.67 | 85.6 |
| Example 4 | | | Li₆Si₂O₇ | | 530 | 3 | Not occurred | 0.20 | 87.8 |
| Example 5 | | | | | 1030 | 5 | Not occurred | 0.18 | 89.1 |
| Example 6 | | | | | 3000 | 20 | Not occurred | 0.05 | 92.6 |
| Example 7 | LiSiOB | Mg | Li₂SiO₃ | MgSiO₃ | 63 | 0.5 | Not occurred | 1.68 | 72.3 |
| Example 8 | | | Li₂Si₂O₅ | Mg₂SiO₄ | 289 | 2 | Not occurred | 0.87 | 81.5 |
| Example 9 | | | Li₄SiO₄ | | 1130 | 5 | Not occurred | 0.54 | 84.1 |
| Example 10 | | | Li₆Si₂O₇ | | 3000 | 14.8 | Not occurred | 0.34 | 88.2 |
| Example 11 | LiSiOC | Mg | Li₂SiO₃ | MgSiO₃ | 209 | 2 | Not occurred | 1.02 | 73.6 |
| Example 12 | | | Li₂Si₂O₅ | Mg₂SiO₄ | 301 | 3 | Not occurred | 0.50 | 86.7 |
| Example 13 | | | Li₄SiO₄ | | 1310 | 5 | Not occurred | 0.43 | 89.6 |
| Example 14 | | | Li₆Si₂O₇ | | 3000 | 19 | Not occurred | 0.22 | 90.2 |

TABLE 2

| | Lithium- | | | | | | | | Capacity |
|---|---|---|---|---|---|---|---|---|---|
| | silicon- | | | | Presence | Molar | | Elution | retention |
| | containing | Surface | Lithium | Magnesium | range | ratio | | amount | rate |
| | oxide | dope | silicate | silicate | R (nm) | M (mol %) | Gelation | (%) | (%) |
| Comparative | LiSiOA | — | Li₂SiO₃ | — | — | — | Occurred | 6.50 | 61.3 |
| example 1 | | | Li₂Si₂O₅ | | | | | | |
| Comparative | LiSiOB | | Li₄SiO₄ | | | | Occurred | 12.20 | 43.7 |
| example 2 | | | Li₆Si₂O₇ | | | | | | |
| Comparative | LiSiOC | | | | | | Occurred | 30.80 | 25.4 |
| example 3 | | | | | | | | | |
| Comparative | LiSiOA | Mg | Li₂SiO₃ | MgSiO₃ | 5 | 0.08 | Occurred | 3.00 | 20.1 |
| example 4 | | | Li₂Si₂O₅ | Mg₂SiO₄ | | | | | |
| Comparative | | | Li₄SiO₄ | | 3940 | 21 | Not | 0.18 | 60.0 |
| example 5 | | | Li₆Si₂O₇ | | | | occurred | | |

As presented in Tables 1 and 2, the capacity retention rate was changed depending on the configuration of the negative electrode active material.

In a case of using the negative electrode active material including the lithium-silicon-containing oxide the surface of which was not doped with magnesium (Comparative examples 1 to 3), the negative electrode mixture slurry was gelated, the elution amount was increased, and the capacity retention rate was decreased.

In contrast, in a case where the surface of the lithium-silicon-containing oxide was doped with magnesium, the capacity retention rate was changed depending on the presence range R and the molar ratio M.

For example, in a case where the surface of the lithium-silicon-containing oxide was doped with magnesium, but the presence range R was not within an appropriate range of greater than or equal to 10 nm and less than or equal to 3000 nm, and the molar ratio M was not within an appropriate range of greater than or equal to 0.1 mol % and less than or equal to 20 mol % (Comparative examples 4 and 5); the negative electrode mixture slurry was gelated, the elution amount was increased, and the capacity retention rate was decreased, as in the above-described case; or the capacity retention rate was decreased although the negative electrode mixture slurry was not gelated and the elution amount was decreased.

In contrast, in a case where the surface of the lithium-silicon-containing oxide was doped with magnesium, and the presence range R and the molar ratio M were within the respective appropriate ranges (Examples 1 to 14), the negative electrode mixture slurry was not gelated, the elusion amount was decreased, and the capacity retention rate was increased. In this case, the capacity retention rate was further increased, in particular, when the presence range R was within a range of greater than or equal to 50 nm and less than or equal to 3000 nm.

According to the results presented in Tables 1 and 2, the capacity retention rate was increased in a case where the negative electrode active material included the lithium-silicon-containing oxide including lithium and silicon as constituent elements and including magnesium present on the surface layer thereof, and where the phase configuration of the lithium-silicon-containing oxide, the presence range of magnesium, the bonding state of magnesium, and the content of magnesium satisfied the above-described respective conditions. It was therefore possible to achieve a superior cyclability characteristic of the secondary battery.

Although the present technology has been described above with reference to one or more embodiments including Examples, the configuration of the present technology is not limited thereto those described, and is therefore modifiable in a variety of suitable ways.

The description has been given of the case where the secondary battery has a battery structure of the laminated-film type; however, the battery structure is not particularly limited. For example, the battery structure may be of a cylindrical type, a prismatic type, a coin type, or a button type.

Further, the description has been given of the case where the battery device has a device structure of a wound type; however, the device structure of the battery device is not particularly limited. The device structure may be, for example, of a stacked type in which the electrodes (the positive electrode and the negative electrode) are stacked on each other, or a zigzag folded type in which the electrodes are folded in a zigzag manner.

Further, the description has been given of the case where the electrode reactant is lithium; however, the electrode reactant is not particularly limited. For example, the electrode reactant may be another alkali metal such as sodium or potassium, or may be an alkaline earth metal such as beryllium, magnesium, or calcium, as described herein. Alternatively, the electrode reactant may be another light metal such as aluminum.

Note that the applications of each of the negative electrode active material for a secondary battery and the negative electrode for a secondary battery are not limited to a secondary battery, and each of the negative electrode active material for a secondary battery and the negative electrode for a secondary battery may thus be applied to another electrochemical device such as a capacitor and the like.

The effects described herein are mere examples, and effects of the present technology are therefore not limited to those described herein. Accordingly, the present technology may achieve other suitable effects.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including a negative electrode active material; and
an electrolytic solution, wherein
the negative electrode active material includes a lithium-silicon-containing oxide that includes lithium and silicon as constituent elements and includes magnesium present on a surface layer of the lithium-silicon-containing oxide,
the lithium-silicon-containing oxide includes a phase including the silicon and a phase including at least one kind of lithium silicate represented below by Formula (1),
a range in which the magnesium is present is within a range of greater than or equal to 10 nanometers and less than or equal to 3000 nanometers from a surface of the lithium-silicon-containing oxide in a depth direction,
the magnesium forms at least one kind of magnesium silicate represented below by Formula (2), and
a ratio of a number of moles of the magnesium to a number of moles of the lithium is greater than or equal to 0.1 mole percent and less than or equal to 20 mole percent,
LiₐSi_{b}O_{c} (1)
where a, b, and c satisfy 1≤a≤6, 1≤b≤3, and 1≤c≤7, respectively,
MgₓSi_{y}O_{z} (2)
where x, y, and z satisfy 1≤x≤3, 1≤y≤2, and 1≤z≤4, respectively.

2. The secondary battery according to claim 1, wherein the lithium silicate includes at least one of Li₂SiO₃, Li₂Si₂O₅, Li₄SiO₄, or Li₆Si₂O₇.

3. The secondary battery according to claim 1, wherein the magnesium silicate includes MgSiO₃, Mg₂SiO₄, or both.

4. The secondary battery according to claim 1, wherein the range is greater than or equal to 50 nanometers and less than or equal to 3000 nanometers.

5. The secondary battery according to claim 4, wherein the secondary battery comprises a lithium-ion secondary battery.

6. A negative electrode for a secondary battery, the negative electrode comprising
a negative electrode active material, wherein
the negative electrode active material includes a lithium-silicon-containing oxide that includes lithium and silicon as constituent elements and includes magnesium present on a surface layer of the lithium-silicon-containing oxide,
the lithium-silicon-containing oxide includes a phase including the silicon and a phase including at least one kind of lithium silicate represented below by Formula (1),
a range in which the magnesium is present is within a range of greater than or equal to 10 nanometers and less than or equal to 3000 nanometers from a surface of the lithium-silicon-containing oxide in a depth direction,
the magnesium forms at least one kind of magnesium silicate represented below by Formula (2), and
a ratio of a number of moles of the magnesium to a number of moles of the lithium is greater than or equal to 0.1 mole percent and less than or equal to 20 mole percent,
LiₐSi_{b}O_{c} (1)
where a, b, and c satisfy 1≤a≤6, 1≤b≤3, and 1≤c≤7, respectively,
MgₓSi_{y}O_{z} (2)
where x, y, and z satisfy 1≤x≤3, 1≤y≤2, and 1≤z≤4, respectively.

7. A negative electrode active material for a secondary battery, the negative electrode active material comprising
a lithium-silicon-containing oxide that includes lithium and silicon as constituent elements and includes magnesium present on a surface layer of the lithium-silicon-containing oxide, wherein
the lithium-silicon-containing oxide includes a phase including the silicon and a phase including at least one kind of lithium silicate represented below by Formula (1),
a range in which the magnesium is present is within a range of greater than or equal to 10 nanometers and less than or equal to 3000 nanometers from a surface of the lithium-silicon-containing oxide in a depth direction,
the magnesium forms at least one kind of magnesium silicate represented below by Formula (2), and
a ratio of a number of moles of the magnesium to a number of moles of the lithium is greater than or equal to 0.1 mole percent and less than or equal to 20 mole percent,
LiₐSi_{b}O_{c} (1)
where a, b, and c satisfy 1≤a≤6, 1≤b≤3, and 1≤c≤7, respectively,
MgₓSi_{y}O_{z} (2)
where x, y, and z satisfy 1≤x≤3, 1≤y≤2, and 1≤z≤4, respectively.
